(19) United States
(12) Patent Application Publication
(10) Pub. No.: US 2021/0315195 A1
(43) Pub. Date: Oct. 14, 2021

(54) DEVICES AND METHODS FOR DISPERSING INSECTS

(71) Applicant: SOUND MEDICINE, LLC, Mill Valley, CA (US)

(72) Inventor: Eli Krasnoff, Mill Valley, CA (US)

(21) Appl. No.: 17/226,876

(22) Filed: Apr. 9, 2021

Related U.S. Application Data
(60) Provisional application No. 63/008,079, filed on Apr. 10, 2020.

(51) Int. Cl. A01M 29/16

(52) U.S. Cl. CPC A01M 29/16; A01M 2200/012

(57) ABSTRACT

Devices and methods for disrupting flying insect activity of one or more flying insects within a zone are provided. One or more first acoustic signals from a first acoustic source are emitted, thereby causing the one or more flying insects to depart the zone. Each respective acoustic signal in the one or more first acoustic signals comprises a corresponding smooth periodic oscillation from the first acoustic source. Each corresponding smooth periodic oscillation independently has a frequency between 250 Hz and 1500 Hz.

### CROSS REFERENCE TO RELATED APPLICATIONS

This application relates to U.S. Provisional Patent Application No. 63/008,079, filed Apr. 10, 2020, the content of which is hereby incorporated by reference, in its entirety, for all purposes.

### TECHNICAL FIELD

The present invention generally relates to devices and methods that control one or more acoustic signals, and systems including the devices that control the acoustic signals.

### BACKGROUND

Mosquito-borne diseases affect both humans and animals and exact a heavy medical toll in endemic countries. Female mosquitoes have the physical apparatus to draw blood and thus transmit the disease to the individual. One approach to limit the spread of such diseases is to control the populations of mosquito vectors (e.g., Anopheles, Aedes, and/or Culex). Conventional methods used to reduce the mosquito population have included oiling and/or draining bodies of water to prevent both the deposition of eggs by females as well as the development of larvae. Other methods include the application of larvicides and insectides to indoor and/or outdoor environments such as residential walls and fields. Each of these methods, however, suffer from a disadvantage of having negative ecological effects, including the destruction of other water-dwelling species and/or pollinizing insects, as well as widespread ecological imbalance. In particular, traditional methods utilizing insecticides can have especially harmful side effects, as these substances are toxic to humans and animals when ingested. See, e.g., Kahn et al., 1945, “Recording of Sounds Produced by Certain Disease-Carrying Mosquitoes,” Science, 335-336.

Another approach to repelling insects is to employ sound as a mosquito repellent. Available methods that employ sound as a mosquito repellent include the use of ultrasonic waves. See, U.S. Pat. No. 7,109,849B2, filed Feb. 24, 2004.

There is a need in the art for more effective, non-harmful mosquito repellents that can reduce the risk of contracting mosquito-borne diseases while avoiding negative side effects to human health and environment.

The citation of the foregoing publications is not an admission that any particular publication constitutes prior art, or that any publication alone or in conjunction with others, renders unpatentable any pending claim of the present application. None of the cited publications is believed to detract from the patentability of the claimed invention.

### SUMMARY

The present invention generally provides devices and methods of dispersing insects by disrupting flying insect activity using acoustic signals.

One aspect of the present disclosure provides a method of disrupting flying insect activity of one or more flying insects within a zone. The method includes emitting one or more first acoustic signals from a first acoustic source, thus causing the one or more flying insects to depart the zone. Each respective acoustic signal in the one or more first acoustic signals includes a corresponding smooth periodic oscillation from the first acoustic source, and each corresponding smooth periodic oscillation independently has a frequency between 250 Hz and 1500 Hz.

In some embodiments, the one or more flying insects are mosquitos. In some embodiments, the one or more flying insects are Aedes, Culex, or Anopheles. In some embodiments, the one or more flying insects are Aedes aegypti or Aedes albopictus.

In some implementations, the one or more first acoustic signals is a single acoustic signal.

In some alternative implementations, the one or more first acoustics signals includes a plurality of acoustic signals including at least a first acoustic signal and a second acoustic signal, and the corresponding smooth periodic oscillation of the second acoustic signal has a frequency other than the frequency of the corresponding smooth periodic oscillation of the first acoustic signal.

In some such implementations, the plurality of acoustic signals includes three, four, five, six, seven, eight, nine, or more than then acoustic signals, where the corresponding smooth periodic oscillation of each respective acoustic signal in the plurality of acoustic signals has a unique frequency. In some implementations, the plurality of acoustic signals is between ten and one thousand acoustic signals, where the corresponding smooth periodic oscillation of each respective acoustic signal in the plurality of acoustic signals has a unique frequency.

In some embodiments, each corresponding smooth periodic oscillation has a frequency between 250 Hz and 1000 Hz. In some embodiments, each corresponding smooth periodic oscillation has a frequency between 500 Hz and 1500 Hz. In some embodiments, each corresponding smooth periodic oscillation has a frequency between 500 Hz and 1000 Hz.

In some embodiments, the zone is a radius of between 0.5 meter and 10 meters about the first acoustic source.

In some embodiments, an acoustic signal in the one or more first acoustic signals is emitted from the first acoustic source at a decibel rating of less than 10 dB. In some embodiments, an acoustic signal in the one or more acoustic signals is emitted from the first acoustic source at a decibel rating of less than 20 dB. In some embodiments, an acoustic signal in the one or more first acoustic signals is emitted from the first acoustic source at a decibel rating of between 5 dB and 70 dB.

In some embodiments, the one or more first acoustic signals are emitted for between one second and one month. In some embodiments, the one or more first acoustic signals are emitted for between one day and four months.

In some embodiments, the first acoustic source is a speaker.

In some implementations, the method further includes emitting one or more second acoustic signals from a second acoustic source concurrently to the emitting the one or more first acoustic signals from the first acoustic source.

Another aspect of the present disclosure provides a computing device including one or more processors, a memory, and a first acoustic source, where the first acoustic source is in electrical communication with the one or more processors, and the memory includes non-transitory instructions that, when executed by the one or more processors, perform a method. The method includes receiving, at the computing device, a request to disrupt flying insect activity of one or more flying insects within a zone about the computing device, and, responsive to the request, emitting from the first acoustic source one or more acoustic signals thus causing the one or more flying insects to depart the zone. Each respective acoustic signal in the one or more first acoustic signals includes a corresponding smooth periodic oscillation from the first acoustic source, and each corresponding smooth periodic oscillation independently has a frequency between 250 Hz and 1500 Hz.

In some embodiments, the computing device is a battery-operated mobile device.

Another aspect of the present disclosure provides a non-transitory computer readable storage medium, where the non-transitory computer readable storage medium stores instructions, which when executed by a computer system, cause the computer system to perform a method for disrupting flying insect activity of one or more flying insects within a zone. The method includes emitting one or more first acoustic signals from a first acoustic source thus causing the one or more flying insects to depart the zone, where each respective acoustic signal in the one or more first acoustic signals includes a corresponding smooth periodic oscillation from the first acoustic source, and each corresponding smooth periodic oscillation independently has a frequency between 250 Hz and 1500 Hz.

The systems and methods of the present invention have other features and advantages that will be apparent from or are set forth in more detail in the accompanying drawings, which are incorporated herein, and the following Detailed Description, which together serve to explain certain principles of the present invention.

### BRIEF DESCRIPTION OF THE DRAWINGS

The accompanying drawings, which are incorporated into and constitute a part of this specification, illustrate one or more embodiments of the present application and, together with the detailed description, serve to explain the principles and implementations of the application.

FIG. 1 is a schematic diagram illustrating an example device of the present invention, in which optional elements are indicated by dashed boxes, in accordance with some embodiments of the present disclosure.

FIGS. 2A, 2B, and 2C provide a block diagram illustrating an example method, in which optional steps are indicated by dashed boxes, in accordance with some embodiments of the present disclosure.

### DETAILED DESCRIPTION

Given the above background, one approach to safe, effective mosquito population control is the use of appropriate sounds or vibrations that have improved mosquito dispersing ability relative to prior art sounds or vibration approaches. Although mosquitoes do not hear sound so much as feel corresponding acoustic waves, there is evidence to suggest that mosquitoes are able to produce as well as respond to characteristic sounds. These sounds target and are received by the two antennae located on the top of the mosquito's head. For instance, laboratory studies indicated that transmitting recordings of noises produced by females caused the antennae of males to turn towards the direction of the sounds. See, e.g., Kahn et al., 1945, “Recording of Sounds Produced by Certain Disease-Carrying Mosquitoes,” Science, 335-336.

The present disclosure provides mosquito-dispersing devices and methods that disrupt flying insect activity of one or more flying insects within a zone. The devices and methods comprise emitting one or more first acoustic signals from a first acoustic source (e.g., a speaker), thereby causing the one or more flying insects to depart the zone. Each respective acoustic signal in the one or more first acoustic signals comprises a corresponding smooth periodic oscillation from the first acoustic source, and each corresponding smooth periodic oscillation independently has a frequency between 250 Hz and 1500 Hz. The vibrations of the acoustic signals in the zone cause one or more flying insects (e.g., mosquitoes) within the zone to disperse upon sensing the vibrations.

Advantageously, the disclosed systems and methods improve upon conventional art because they are non-harmful to the human body. In some preferred embodiments, the discloses systems and methods produce the acoustic signals electronically, for instance using a mobile device. Advantageously, the disclosed systems and methods can be used as a large-scale replacement for pesticides, with broad use across multiple species of pests. For example, the disclosed systems and methods can be used by medical workers in endemic countries to prevent the spread of vector-borne (e.g., mosquito-borne) diseases.

Reference will now be made in detail to implementations of the present application as illustrated in the accompanying drawings. The same reference indicators will be used throughout the drawings and the following detailed description to refer to the same or like parts. Those of ordinary skill in the art will realize that the following detailed description of the present application is illustrative only and is not intended to be in any way limiting. Other embodiments of the present application will readily suggest themselves to such skilled persons having benefit of this disclosure.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming but would nevertheless be a routine undertaking of engineering for those of ordinary skill in the art having the benefit of this disclosure.

Many modifications and variations of this disclosure can be made without departing from its spirit and scope, as will be apparent to those skilled in the art. The specific embodiments described herein are offered by way of example only, and the disclosure is to be limited only by the terms of the appended claims, along with the full scope of equivalents to which such claims are entitled.

Embodiments of the present invention are described in the context of devices, systems and methods that control one or more acoustic signals to disrupt flying insect activity of one or more flying insects within a zone.

As used herein, the term “acoustic signal” refers to a sound signal or vibration that is produced and transmitted by a device. In some embodiments, an acoustic signal is electronic or analog.

As used herein, the term “acoustic source” refers to a source (e.g., a device) from which an acoustic signal is produced.

As used herein, the term “frequency” refers to its meaning as commonly understood by one of ordinary skill in the art. A frequency is the rate at which a vibration or wave occurs, such as a sound wave, at a fixed point within a given amount of time. Generally, frequencies for sound waves are measured in hertz (Hz), or number of waves per second.

As used herein, the term “smooth periodic oscillation” refers to a continuous wave shape, such as a sine wave. In some embodiments, a sound wave, such as one produced by an acoustic signal, is characterized by a smooth periodic oscillation or a sine wave and contains a single frequency without harmonics.

As used herein, the term “zone” refers to a radius or region from which dispersal of one or more pests (e.g., flying insects) is desired. In some embodiments, a zone refers to a radius or region about one or more emitting devices. In some embodiments, the zone comprises the maximum distance at which sound and/or vibrations from the one or more emitting devices can be detected. In some embodiments, the zone comprises the maximum distance at which sound and/or vibrations from the one or more emitting devices can be detected at a given intensity. In some embodiments, the size of the zone varies depending on the intensity (e.g., in decibels dB) of the sound and/or vibrations emitted from the one or more emitting devices.

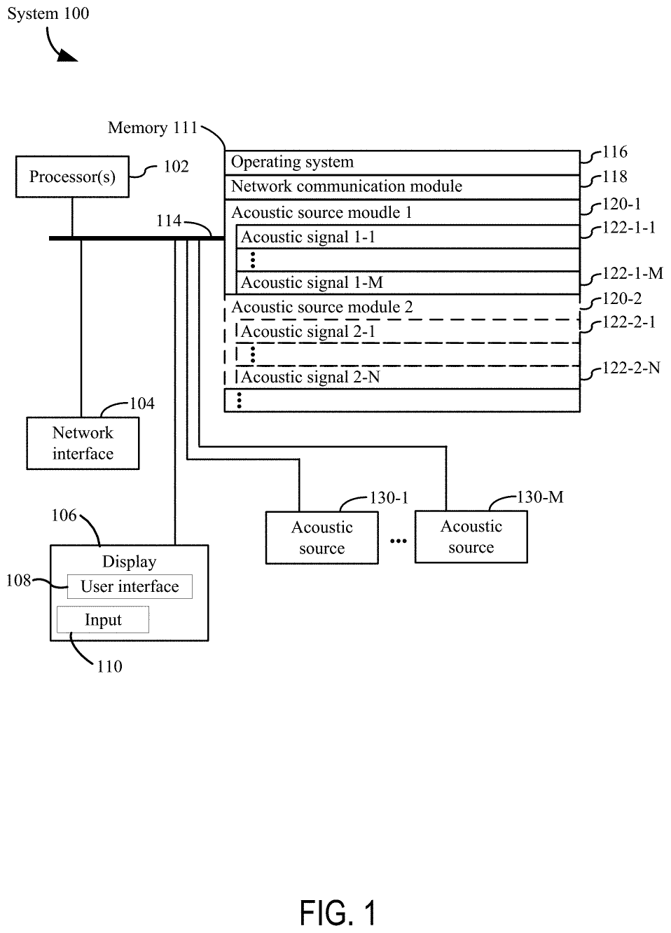

Referring now to FIG. 1, there is depicted an exemplary device 100 in accordance with some embodiments of the present disclosure. By way of illustration, FIG. 1 shows the device for disrupting flying insect activity of one or more flying insects within a zone, in accordance with some implementations.

The device 100 in some implementations includes at least one or more processing units CPU(s) 102 (also referred to as processors), one or more network interfaces 104, a display 106 having a user interface 108, an input device 110, a memory 111, one or more acoustic source 130 (e.g., acoustic sources 130-1, . . . , 130-M, where M is a positive integer), and one or more communication buses 114 for interconnecting these components. The one or more communication buses 114 optionally include circuitry (sometimes called a chipset) that interconnects and controls communications between system components. The memory 111 may be a non-persistent memory, a persistent memory, or any combination thereof. The non-persistent memory typically includes high-speed random access memory, such as DRAM, SRAM, DDR RAM, ROM, EEPROM, flash memory, whereas the persistent memory typically includes CD-ROM, digital versatile disks (DVD) or other optical storage, magnetic cassettes, magnetic tape, magnetic disk storage or other magnetic storage devices, magnetic disk storage devices, optical disk storage devices, flash memory devices, or other non-volatile solid-state storage devices. Regardless of its specific implementation, memory 111 comprises at least one non-transitory computer-readable storage medium, and it stores thereon computer-executable executable instructions which can be in the form of programs, modules, and data structures.

In some embodiments, as shown in FIG. 1, the memory 111 stores the following:
an operating system 116, which includes procedures for handling various basic system services and for performing hardware-dependent tasks;
an optional network communication module (or instructions) 118 for connecting the device 100 with other devices and/or to a communication network;
a first acoustic source module 120 (e.g., 120-1) that, when executed by the one or more processors 102, performs a method comprising emitting from the first acoustic source 130 one or more acoustic signals 122 (e.g., 122-1-1, . . . , 122-1-M), where each respective acoustic signal in the one or more first acoustic signals comprises a corresponding smooth periodic oscillation from the first acoustic source, and each corresponding smooth periodic oscillation independently has a frequency between 250 Hz and 1500 Hz; and
optionally, a second acoustic source model 120 (e.g., 120-2) that, when executed by the one or more processors 102, performs a method comprising emitting from a second acoustic source 130 one or more acoustic signals 122 (e.g., 122-2-1, . . . , 122-2-N).

In various implementations, one or more of the above-identified elements are stored in one or more of the previously mentioned memory devices and correspond to a set of instructions for performing various methods described herein. The above-identified modules, data, or programs (e.g., sets of instructions) need not be implemented as separate software programs, procedures, datasets, or modules, and thus various subsets of these modules and data may be combined or otherwise re-arranged in various implementations. In some implementations, the memory 111 optionally stores a subset of the modules and data structures identified above. Furthermore, in some embodiments, the memory stores additional modules and data structures not described above. In some embodiments, one or more of the above-identified elements is stored in a computer system, other than that of the device 100, that is addressable by the device 100 so that the device 100 may retrieve all or a portion of such data when needed.

Although FIG. 1 depicts a “device 100,” the figure is intended more as a functional description of the various features that may be present in computing devices than as a structural schematic of the implementations described herein. In practice, and as recognized by those of ordinary skill in the art, items shown separately could be combined and some items can be separate. Moreover, although FIG. 1 depicts certain data and modules in the memory 111 (which can be non-persistent or persistent memory), it should be appreciated that these data and modules, or portion(s) thereof, may be stored in more than one memory.

While a device in accordance with the present disclosure has been disclosed with reference to FIG. 1, methods in accordance with the present disclosure are now detailed.

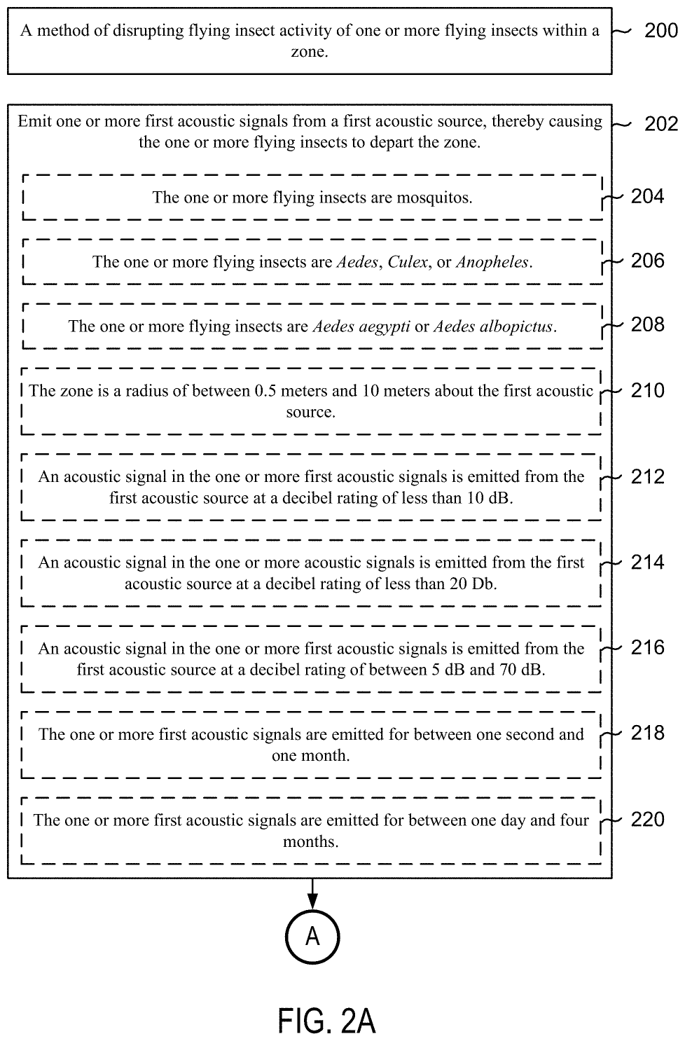

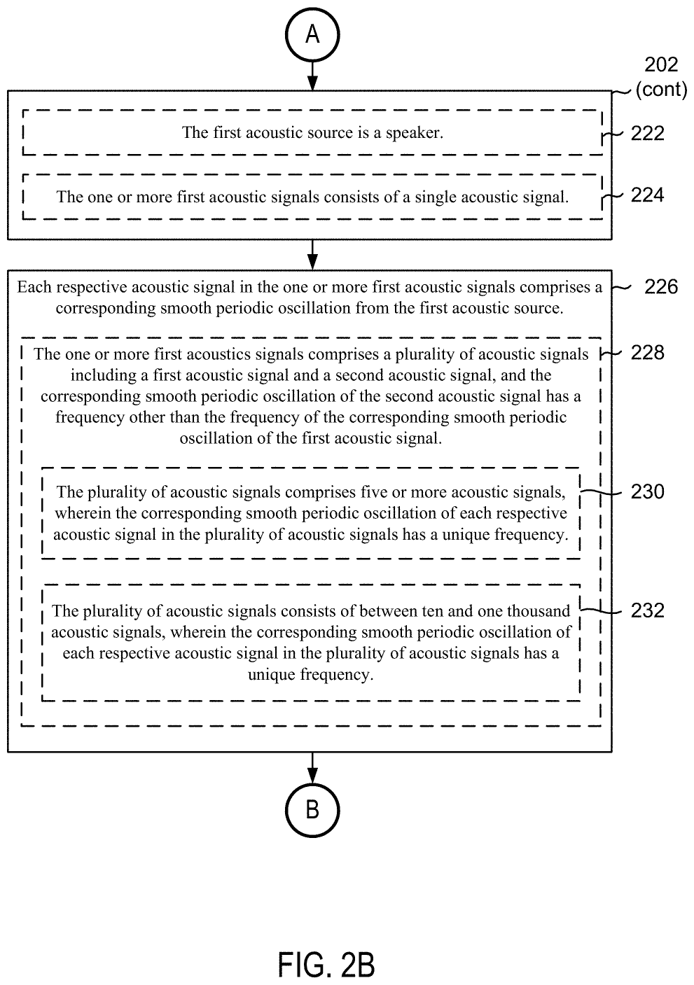

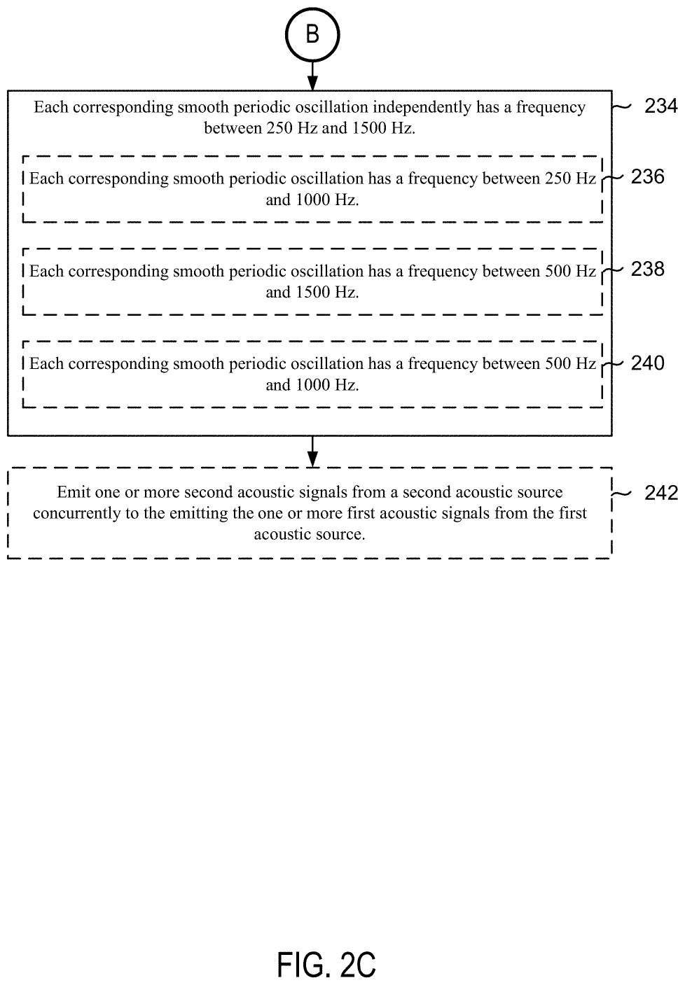

FIG. 2 illustrates a block diagram of an example workflow in accordance with some embodiments of the present disclosure.

Referring to FIG. 2, a method 200 of disrupting flying insect activity of one or more flying insects within a zone is provided. Referring to Block 202, the method comprises emitting one or more first acoustic signals from a first acoustic source thereby causing the one or more flying insects to depart the zone.

Pests and vector-borne diseases. As described above, in some embodiments, the presently disclosed devices and methods comprise disrupting the activity of one or more pests. Non-limiting examples of pests include mammals (e.g., mice and/or rats) and insects (e.g., ants, bed bugs, beetles, mites, earwigs, flies, mosquitoes, moths, lice, fleas, ticks, and/or termites). For instance, in some embodiments, the one or more pests comprise one or more insects, including, but not limited to, mosquitoes (e.g., Aedes, Culex, and/or Anopheles spp.), blackflies (e.g., Simulium, Prosimulium, Austrosimulium, and/or Cnephia spp.), fleas (e.g., Ctenocephalides, Pulex, Echidnophaga, Tunga, and/or Xenopsylla spp.), lice (e.g., Pediculus and/or Pthirus spp.), sandflies (e.g., Luzomyia and/or Phlebotomus spp.), ticks (e.g., Ixodes, Dermacentor, Amblyomma, and/or Rhipicephalus spp.) triatomine bugs (e.g., Triatoma, Rhodnius, and Panstrongylus spp.), and/or tsetse flies (e.g., Glossina spp.).

In some embodiments, the one or more pests comprise one or more disease-carrying pests (e.g., vector-borne disease). In some embodiments, the disease is a human-infective vector-borne disease. In some embodiments, the vector-borne disease is Adria virus, African trypanosomiasis (sleeping sickness), Anaplasmosis (Anaplasma phagocytophilum), Bacillary angiomatosis, Banna virus, Batai virus, Bartonella (cat scratch disease, trench fever, and Carrión's disease), Borrelia mayonii, Borrelia miyamotoi, Bourbon virus, Bunyamwera fever, Bwamba fever, Cache Valley virus, California encephalitis, Cat scratch disease (Bartonella henselae), Chagas disease, Chandipura vesiculovirus, Chikungunya, Colorado tick fever, Dengue, Dirofilariasis, Eastern equine encephalitis virus, Ehrlichiosis, Epidemic typhus (Rickettsia prowazekii), Heartland virus, Jamestown Canyon virus, Japanese encephalitis, La Crosse virus, Leishmaniasis, Loa loa filariasis, Lyme disease (Borrelia burgdorferi), Lymphatic filariasis, Malaria, Mansonelliasis, Mayaro virus, Murine typhus (Rickettsia typhi), Murray Valley encephalitis virus, Myiasis (Dermatobia hominis), Onchocerciasis (river blindness), O'nyong-o'nyong virus, Oropouche fever, Pappataci fever, Plague (Yersinia pestis), Pogosta disease, Powassan virus, Q fever (Coxiella burnetii), Rickettsia, Rickettsialpox, Rift Valley fever, Rocky Mountain spotted fever, Rocio viral encephalitis, Ross River virus, Scrub typhus (Orientia tsutsugamushi), Saint Louis encephalitis virus, Semliki Forest virus, Sinbis, Spondweni fever, Spotted fever group rickettsioses, START (Southern tick-associated rash illness), Tahyna virus, Tete virus, Tickborne encephalitis virus, Tickborne relapsing fever (Borrelia hermsii, B. turicatae, and B. parkerii), Tularemia (Francisella tularensis), Typhus fevers, Usutu virus, Venezuelan equine encephalitis virus, West Nile virus, Western equine encephalitis virus, Yellow fever, and/or Zika virus.

In some embodiments, the one or more pests comprise one or more flying insects. For instance, referring to Block 204, in some embodiments, the one or more flying insects comprise mosquitos. Referring to Block 206, in some embodiments, the one or more flying insects are Aedes, Culex, or Anopheles. Referring to Block 208, in some embodiments, the one or more flying insects are Aedes aegypti or Aedes albopictus.

In some embodiments, the method is utilized to disrupt the flying insect activity of one or more flying insects other than mosquitoes. In some embodiments, the method is utilized to dispel one or more pests other than flying insects.

In some embodiments, the method is utilized to dispel and/or disrupt the activity of at least 1, at least 2, at least 3, at least 4, at least 5, at least 6, at least 7, at least 8, at least 9, at least 10, at least 15, at least 20, at least 30, at least 40, at least 50, at least 60, at least 70, at least 80, at least 90, or at least 100 different species of insects. In some embodiments, the method is utilized to dispel and/or disrupt the activity of no more than 200, no more than 100, no more than 90, no more than 80, no more than 70, no more than 60, no more than 50, no more than 40, no more than 30, no more than 20, or no more than 10 different species of insects. In some embodiments, the method is utilized to dispel and/or disrupt the activity of from 1 to 5, from 5 to 10, from 2 to 20, from 15 to 50, from 20 to 100, or from 50 to 200 different species of insects. In some embodiments, the method is utilized to dispel and/or disrupt the activity of a plurality of species that falls within another range starting no lower than 2 and ending no higher than 200 different species of insects.

In some embodiments, the method is utilized to dispel and/or disrupt the activity of at least 1, at least 2, at least 3, at least 4, at least 5, at least 6, at least 7, at least 8, at least 9, or at least 10 different genera of insects. In some embodiments, the method is utilized to dispel and/or disrupt the activity of no more than 20, no more than 15, no more than 10, no more than 5, or no more than 3 different genera of insects. In some embodiments, the method is utilized to dispel and/or disrupt the activity of from 1 to 3, from 2 to 5, from 5 to 10, or from 10 to 20 different genera of insects. In some embodiments, the method is utilized to dispel and/or disrupt the activity of a plurality of genera that falls within another range starting no lower than 2 and ending no higher than 20 different genera of insects.

Zones. As defined above, a zone refers to a radius or region from which the one or more insects (e.g., flying insects) are dispersed, e.g., a radius about one or more emitting devices (e.g., acoustic sources). For example, in some embodiments, a zone is a radius or region about a subject (e.g., a human) from which dispersal of insects (e.g., flying insects) is desired. In some embodiments, a zone is a radius or region about one or more acoustic sources (e.g., a first acoustic source).

In some embodiments, the zone has a radius of at least 0.1 meters, at least 0.2, meters, at least 0.3 meters, at least 0.4 meters, at least 0.5 meters, at least 0.6 meters, at least 0.7 meters, at least 0.8 meters, at least 0.9 meters, at least 1 meter, at least 1.5 meters, at least 2 meters, at least 2.5 meters, at least 3 meters, at least 3.5 meters, at least 4 meters, at least 4.5 meters, at least 5 meters, at least 6 meters, at least 7 meters, at least 8 meters, at least 9 meters, at least 10 meters, at least 11 meters, at least 12 meters, at least 13 meters, at least 14 meters, at least 15 meters, at least 16 meters, at least 17 meters, at least 18 meters, at least 19 meters, at least 20 meters, at least 30 meters, or more. In some embodiments, the zone has a radius of no more than 50 meters, no more than 40 meters, no more than 30 meters, no more than 20 meters, no more than 15 meters, no more than 10 meters, or no more than 5 meters. In some embodiments, the zone has a radius of from 0.1 to 0.5 meters, from 0.5 to 1 meter, from 1 to 2 meters, from 2 to 5 meters, from 5 to 10 meters, from 10 to 20 meters, or from 20 to 50 meters. In some embodiments, the zone has a radius that falls within another range starting no lower than 0.1 meters and ending no higher than 50 meters.

Thus, for instance, referring to Block 210, in some embodiments, the zone is a radius of between 0.5 meter and 10 meters about the first acoustic source. In some embodiments, the zone is a radius of between 0.1 and 0.5 meters, between 0.5 and 1 meter, between 1 and 2 meters, between 2 and 5 meters, between 5 and 10 meters, between 10 and 20 meters, or greater than 20 meters about the first acoustic source.

In some embodiments, the method comprises placing one or more acoustic sources that emit one or more acoustic signals within a zone, such that the one or more acoustic signals cause the one or more insects (e.g., flying insects) to depart the zone.

In some embodiments, a zone comprises the maximum distance from an acoustic source at which various sounds or vibrations can be detected. In some embodiments, a zone comprises the maximum distance from the acoustic source at which sound and/or vibrations can be detected at a specified intensity (e.g., an effective range). In some embodiments, a size or range of the zone can be modulated depending on the intensity (e.g., in decibels dB), the frequency, and/or other characteristics of the sound and/or vibrations emitted from the acoustic source. In some embodiments, a zone is indoors, outdoors, or both.

In some embodiments, a zone is spherical and/or symmetrical in shape. In some embodiments, a zone is oblong in shape. In some embodiments, a zone is any 3-dimensional space, the bounds of which are determined by the effective range of the one or more acoustic signals emitted by the one or more acoustic sources.

Thus, in some embodiments, the method comprises placing one or more acoustic sources within a desired target area, in order to cause insect dispersal within the target area. In some embodiments, the one or more acoustic sources are placed inside and/or outside of the zone. In some embodiments, the one or more acoustic sources are placed at the center of the zone. In some embodiments, the one or more acoustic sources are placed at the edges and/or around the perimeter of the zone. In some embodiments, placement of one or more acoustic sources within or around a zone is performed using any layout sufficient for coverage of the zone by the one or more acoustic signals from the respective one or more acoustic sources, as will be apparent to one skilled in the art.

In some embodiments, the zone is a field site. In some embodiments, the zone is a remote site (e.g., for a medical worker or a medical practitioner). In some such embodiments, the method is utilized by a medical worker or a medical practitioner in a field site and/or a remote site.

Acoustic signals. In some embodiments, the method comprises emitting one or more acoustic signals from one or more acoustic sources to induce dispersal of insects (e.g., flying insects). For instance, in some embodiments, the one or more acoustic sources is a plurality of acoustic sources, where each respective acoustic source in the plurality of acoustic sources emits a respective one or more acoustic signals. In some embodiments, the one or more acoustic sources comprises at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 25, at least 30, at least 35, at least 40, at least 45, or at least 50 acoustic sources. In some embodiments, the one or more acoustic sources comprises no more than 100, no more than 50, no more than 40, no more than 30, no more than 20, no more than 10, or no more than 5 acoustic sources. In some embodiments, the one or more acoustic sources is from 1 to 5, from 2 to 10, from 5 to 15, from 10 to 20, from 15 to 30, from 20 to 50, or from 40 to 100 acoustic sources. In some embodiments, the one or more acoustic sources falls within another range starting no lower than 2 acoustic sources and ending no higher than 100 acoustic sources.

In some embodiments, the one or more acoustic sources comprises a first acoustic source, where the first acoustic source emits a respective one or more first acoustic signals.

Referring to Block 224, in some embodiments, the one or more first acoustic signals consists of a single acoustic signal. In some embodiments, the one or more first acoustic signals comprises a plurality of acoustic signals. For example, in some embodiments, the one or more first acoustic signals comprises at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 25, at least 30, at least 35, at least 40, at least 45, at least 50, at least 60, at least 70, at least 80, at least 90, at least 100, at least 150, at least 200, at least 300, at least 400, at least 500, at least 600, at least 700, at least 800, at least 900, or at least 1000 acoustic signals. In some embodiments, the one or more first acoustic signals comprises no more than 1000, no more than 900, no more than 800, no more than 700, no more than 600, no more than 500, no more than 400, no more than 300, no more than 100, no more than 50, no more than 40, no more than 30, no more than 20, no more than 10, or no more than 5 acoustic signals. In some embodiments, the one or more first acoustic signals comprises from 1 to 5, from 2 to 10, from 5 to 15, from 10 to 20, from 15 to 30, from 20 to 50, from 40 to 100, from 50 to 200, from 100 to 300, from 200 to 400, from 200 to 500, from 500 to 800, or from 200 to 1000 acoustic signals. In some embodiments, the one or more acoustic signals comprises a plurality of acoustic signals falling within another range starting no lower than 2 acoustic signals and ending no higher than 1000 acoustic signals.

In some embodiments, each respective acoustic signal in a respective one or more acoustic signals (e.g., emitted by a respective acoustic source in one or more acoustic sources) comprises the same parameters as every other acoustic signal in the respective one or more acoustic signals (e.g., waveform, frequency, duration, intensity, and/or pattern). In some embodiments, a first acoustic signal in the one or more acoustic signals comprises different parameters from a second acoustic signal in the one or more acoustic signals (e.g., at least one of waveform, frequency, duration, intensity, and/or pattern).

In some embodiments, each respective acoustic signal in a respective one or more acoustic signals can comprise any of the characteristics of acoustic signals (e.g., waveform, frequency, duration, intensity, and/or pattern) described below, or any substitutions, modifications, additions, deletions, and/or combinations as will be apparent to one skilled in the art.

Waveforms. In some embodiments, an acoustic signal emitted by a respective acoustic source comprises a corresponding smooth periodic oscillation from the first acoustic source. The smooth periodic oscillation of each acoustic signal in the one or more first acoustic signals refers to a continuous wave shape, such as a sine wave. Thus, in some embodiments, an acoustic signal emitted by an acoustic source comprises a continuous (e.g., sinusoidal) waveform. In some embodiments, an acoustic signal emitted by an acoustic source comprises a non-sinusoidal waveform. Non-limiting examples of non-sinusoidal waveforms that are used in some embodiments of the present disclosure include, but are not limited to, sawtooth waveforms, square waveforms, triangle waveforms, zigzag waveforms, trapezoidal waveforms, quasitrapezodial waveforms, complex waveforms, and/or any combination thereof. In some embodiments, an acoustic signal emitted by an acoustic source comprises a periodic waveform. In some embodiments, an acoustic signal emitted by an acoustic source comprises a nonperiodic waveform.

In some embodiments, the one or more first acoustic signals comprises a plurality of acoustic signals, where each respective acoustic signal in the plurality of acoustic signals comprises the same waveform as every other acoustic signal in the plurality of acoustic signals. Thus, referring to Block 226, in some embodiments, each respective acoustic signal in the one or more first acoustic signals comprises a corresponding smooth periodic oscillation from the first acoustic source (e.g., having a frequency of between 250 Hz and 1500 Hz). In some embodiments, each respective acoustic signal in the one or more first acoustic signals comprises a complex oscillation from the first acoustic source (e.g., having a frequency of between 250 Hz and 1500 Hz). In some embodiments, each respective acoustic signal in the one or more first acoustic signals comprises a non-sinusoidal waveform from the first acoustic source (e.g., having a frequency of between 250 Hz and 1500 Hz). In some embodiments, the one or more first acoustic signals comprises a plurality of acoustic signals, where at least a first acoustic signal in the one or more acoustic signals comprises a different waveform from a second acoustic signal in the one or more first acoustic signals.

In some embodiments, the one or more first acoustic signals comprises a plurality of acoustic signals, where each respective acoustic signal in the plurality of acoustic signals comprises the same waveform as every other acoustic signal in the plurality of acoustic signals, and at least a first acoustic signal in the one or more acoustic signals has a different parameter other than waveform (e.g., frequency, duration, intensity, and/or pattern) from a second acoustic signal in the one or more first acoustic signals.

Thus, referring to Block 228, in some embodiments, the one or more first acoustic signals comprises a plurality of acoustic signals including a first acoustic signal and a second acoustic signal, and the corresponding smooth periodic oscillation of the second acoustic signal has a frequency other than the frequency of the corresponding smooth periodic oscillation of the first acoustic signal. Referring to Block 230, in some embodiments, the plurality of acoustic signals comprises at least three, at least four, at least five, at least six, at least seven, at least eight, at least nine, or at least ten acoustic signals, where the corresponding smooth periodic oscillation of each respective acoustic signal in the plurality of acoustic signals has a unique frequency. Referring to Block 232, in some embodiments, the plurality of acoustic signals consists of between ten and one thousand acoustic signals, where the corresponding smooth periodic oscillation of each respective acoustic signal in the plurality of acoustic signals has a unique frequency.

Frequency. In some embodiments, an acoustic signal emitted by a respective acoustic source comprises any corresponding waveform from the first acoustic source, as disclosed herein (e.g., a smooth periodic oscillation), and further comprises a corresponding frequency. In some embodiments, an acoustic signal emitted by a respective acoustic source comprises any corresponding waveform from the first acoustic source, as disclosed herein (e.g., a smooth periodic oscillation), with a frequency of at least 10 Hz, at least 20 Hz, at least 30 Hz, at least 40 Hz, at least 50 Hz, at least 100 Hz, at least 150 Hz, at least 200 Hz, at least 250 Hz, at least 300 Hz, at least 350 Hz, at least 400 Hz, at least 450 Hz, at least 500 Hz, at least 550 Hz, at least 600 Hz, at least 650 Hz, at least 700 Hz, at least 750 Hz, at least 800 Hz, at least 850 Hz, at least 900 Hz, at least 950 Hz, at least 1000 Hz, at least 1050 Hz, at least 1100 Hz, at least 1150 Hz, at least 1200 Hz, at least 1250 Hz, at least 1300 Hz, at least 1350 Hz, at least 1400 Hz, at least 1450 Hz, at least 1500 Hz, at least 1550 Hz, at least 1600 Hz, at least 1650 Hz, at least 1700 Hz, at least 1750 Hz, at least 1800 Hz, at least 1850 Hz, at least 1900 Hz, at least 1950 Hz, at least 2000 Hz, at least 2100 Hz, at least 2200 Hz, at least 2300 Hz, at least 2400 Hz, or at least 2500 Hz. In some embodiments, an acoustic signal emitted by a respective acoustic source comprises any corresponding waveform from the first acoustic source, as disclosed herein (e.g., a smooth periodic oscillation), with a frequency of no more than 2500 Hz, no more than 2250 Hz, no more than 2000 Hz, no more than 1900 Hz, no more than 1800 Hz, no more than 1700 Hz, no more than 1600 Hz, no more than 1500 Hz, no more than 1400 Hz, no more than 1300 Hz, no more than 1200 Hz, no more than 1100 Hz, no more than 1000 Hz, no more than 900 Hz, no more than 800 Hz, no more than 700 Hz, no more than 600 Hz, no more than 500 Hz, no more than 400 Hz, no more than 300 Hz, no more than 200 Hz, or no more than 100 Hz. In some embodiments, an acoustic signal emitted by a respective acoustic source comprises any corresponding waveform from the first acoustic source, as disclosed herein (e.g., a smooth periodic oscillation), with a frequency of from 10 to 100 Hz, from 50 to 300 Hz, from 200 to 500 Hz, from 200 to 1000 Hz, from 250 to 2000 Hz, from 100 to 2000 Hz, from 1000 to 2500 Hz, from 250 to 1500 Hz, 250 to 1000 Hz, from 500 to 1500 Hz, or from 500 and 1000 Hz. In some embodiments, an acoustic signal emitted by a respective acoustic source comprises any corresponding waveform from the first acoustic source, as disclosed herein (e.g., a smooth periodic oscillation), with a frequency that falls within another range starting no lower than 10 Hz and ending no higher than 2500 Hz.

In some embodiments, an acoustic signal in the one or more acoustic signals emitted by a respective acoustic source comprises any corresponding waveform from the first acoustic source, as disclosed herein (e.g., a smooth periodic oscillation), where the frequency is pulsed. For instance, in some implementations, the frequency of a corresponding waveform for a respective acoustic signal can be modulated, or changed, at random or regular intervals.

In some embodiments, an acoustic signal in the one or more acoustic signals emitted by a respective acoustic source comprises any corresponding waveform from the first acoustic source, as disclosed herein (e.g., a smooth periodic oscillation), where the frequency is pulsed at an interval that differs from a multiple of the wingbeat of the one or more flying insects. See, for example, Arthur et al., 2014, “Mosquito (Aedes aegypti) flight tones: Frequency, harmonicity, spherical spreading, and phase relationships,” J Acoust Soc Am 135(2): 933-941, doi: 10.1121/1.4861233, which is hereby incorporated herein by reference in its entirety. In some embodiments, each corresponding waveform (e.g., smooth periodic oscillation) is a complex waveform.

In some embodiments, the frequency of each corresponding waveform (e.g., smooth periodic oscillation) for each respective acoustic signal in the one or more acoustic signals emitted by a respective acoustic source is modulated or alternated in a repeating pattern (e.g., increased and/or decreased at varying intervals).

In some embodiments, an acoustic signal in the one or more acoustic signals emitted by a respective acoustic source comprises any corresponding waveform from the first acoustic source, as disclosed herein (e.g., a smooth periodic oscillation), where the frequency is not pulsed.

In some embodiments, the frequency of the mosquito-dispersing device is below the ultrasonic range.

In some embodiments, each respective acoustic signal in the one or more acoustic signals emitted by a respective acoustic source comprises a frequency independent from any other acoustic signal in the one or more acoustic signals. Thus, referring again to the method 200 in Block 234, each corresponding smooth periodic oscillation for each respective acoustic signal in the one or more first acoustic signals independently has a frequency between 250 Hz and 1500 Hz. For example, referring to Blocks 236, 238 and 240, in some embodiments, each corresponding smooth periodic oscillation has a frequency between 250 Hz and 1000 Hz, between 500 Hz and 1500 Hz, or between 500 Hz and 1000 Hz.

In some embodiments, at least a first acoustic signal in the one or more acoustic signals emitted by a respective acoustic source has a different frequency from a second acoustic signal in the one or more acoustic signals emitted by the respective acoustic source.

Thus, in some embodiments, the one or more first acoustic signals emitted by the first acoustic source comprises a plurality of acoustic signals including a first acoustic signal and a second acoustic signal, and the corresponding second acoustic signal has a frequency other than the frequency of the corresponding first acoustic signal. In some embodiments, the plurality of acoustic signals comprises at least three, at least four, at least five, at least six, at least seven, at least eight, at least nine, or at least ten acoustic signals, where each respective acoustic signal in the plurality of acoustic signals has a unique frequency and is independently one of smooth periodic or non-periodic. Thus, for example, in some embodiments, one of the acoustic signals is periodic and another of the acoustic signals is non-periodic. In some embodiments, the plurality of acoustic signals consists of between ten acoustic signals and one thousand acoustic signals, where each respective acoustic signal in the plurality of acoustic signals has a unique frequency.

In some embodiments, the frequency of each corresponding waveform (e.g., smooth periodic oscillation) for each respective acoustic signal in the one or more acoustic signals emitted by a respective acoustic source is fixed. In some alternative embodiments, the frequency of each corresponding waveform (e.g., smooth periodic oscillation) for each respective acoustic signal in the one or more acoustic signals emitted by a respective acoustic source is not fixed and can be changed to any other frequency in the range of frequencies disclosed herein. In some embodiments, the change in frequency is performed or selected by a user. In some embodiments, the change in frequency is hardwired or programmed (e.g., using a pattern of increasing and decreasing frequencies at varying intervals, as disclosed above).

Intensity. In some embodiments, an acoustic signal in the one or more acoustic signals emitted by a respective acoustic source comprises an intensity (e.g., an amplitude). In some embodiments, the intensity of an acoustic signal is measured in decibels (dB).

In some embodiments, an acoustic signal in the one or more acoustic signals emitted by a respective acoustic source has a decibel rating of at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 25, at least 30, at least 35, at least 40, at least 45, at least 50, at least 60, at least 70, at least 80, at least 90, at least 100, at least 110, at least 120, at least 130, at least 140, at least 150, at least 160, at least 170, at least 180, at least 190, or at least 200 dB. In some embodiments, an acoustic signal in the one or more acoustic signals emitted by a respective acoustic source has a decibel rating of no more than 200, no more than 150, no more than 100, no more than 90, no more than 80, no more than 70, no more than 60, no more than 50, no more than 40, no more than 30, no more than 20, no more than 10, or no more than 5 dB. In some embodiments, an acoustic signal in the one or more acoustic signals emitted by a respective acoustic source has a decibel rating of from 1 to 10, from 5 to 20, from 10 to 30, from 20 to 50, from 20 to 80, from 10 to 20, from 20 to 30, from 30 to 40, from 40 to 50, from 50 to 60, from 60 to 70, from 50 to 100, or from 50 to 200 dB. In some embodiments, an acoustic signal in the one or more acoustic signals emitted by a respective acoustic source has a decibel rating that falls within another range starting no lower than 1 dB and ending no higher than 200 dB.

Thus, referring to Block 212, in some embodiments, an acoustic signal in the one or more first acoustic signals is emitted from the first acoustic source at a decibel rating of less than 10 dB. Referring to Block 214, in some embodiments, an acoustic signal in the one or more acoustic signals is emitted from the first acoustic source at a decibel rating of less than 20 dB. In some embodiments, referring to Block 216, an acoustic signal in the one or more first acoustic signals is emitted from the first acoustic source at a decibel rating of between 5 dB and 70 dB. In some embodiments, an acoustic signal in the one or more first acoustic signals is emitted from the first acoustic source at a decibel rating of between 1 and 10 dB, between 10 and 20 dB, between 20 and 30 dB, between 30 and 40 dB, between 40 and 50 dB, between 50 and 60 dB, between 60 and 70 dB, or greater than 70 dB.

In some embodiments, the intensity (e.g., the amplitude) of an acoustic signal can be varied to increase or decrease the effect or range of the dispersal of one or more insects (e.g., flying insects).

For instance, in some embodiments, an acoustic signal emitted by a respective acoustic source comprises an intensity (e.g., an amplitude) at a level such that the acoustic signal can be detected (e.g., by an insect) at all points within the desired zone of effect. In some embodiments, an acoustic signal emitted by a respective acoustic source comprises an intensity (e.g., an amplitude) at a level such that the acoustic signal can be detected (e.g., by an insect) at a threshold intensity (e.g., an effective intensity) at all points within the desired zone of effect.

In some embodiments, the threshold intensity is a decibel rating of at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 25, at least 30, at least 35, at least 40, at least 45, at least 50, at least 60, at least 70, at least 80, at least 90, at least 100, or at least 200 dB. In some embodiments, the threshold intensity is a decibel rating of no more than 200, no more than 100, no more than 90, no more than 80, no more than 70, no more than 60, no more than 50, no more than 40, no more than 30, no more than 20, no more than 10, or no more than 5 dB. In some embodiments, the threshold intensity is a decibel rating of from 1 to 10, from 5 to 20, from 10 to 30, from 20 to 50, from 20 to 80, from 10 to 20, from 20 to 30, from 30 to 40, from 40 to 50, from 50 to 60, from 60 to 70, from 50 to 100, or from 100 to 200 dB. In some embodiments, the threshold intensity is a decibel rating that falls within another range starting no lower than 1 dB and ending no higher than 200 dB.

In some embodiments, the method comprises modulating the intensity (e.g., in decibels (dB)) of one or more acoustic signals emitted by a respective acoustic source for the dispersal of insects (e.g., flying insects). In some embodiments, modulation of intensity further modulates the size of the zone and/or the range of the dispersal effect. For instance, in some implementations, the intensity of one or more acoustic signals emitted by a respective acoustic source is increased, thus increasing the range of the dispersal effect and correspondingly increasing the size of the zone. Furthermore, in some implementations, the intensity of one or more acoustic signals emitted by a respective acoustic source can be increased, in order to raise the intensity of the acoustic signals to at least a threshold intensity at all points within the desired zone.

Duration and intervals. In some embodiments, an acoustic signal in the one or more acoustic signals emitted by a respective acoustic source comprises a periodic and/or a continuous emission.

For instance, in some embodiments, an acoustic signal in the one or more acoustic signals emitted by a respective acoustic source is pulsed. In some alternative embodiments, an acoustic signal in the one or more acoustic signals emitted by a respective acoustic source is not pulsed. In some embodiments, a pulsed signal is characterized by a period of emission followed by a period during which a signal is not emitted by the acoustic source (e.g., an “on-off” pattern). In some embodiments, pulse intervals for an acoustic signal emitted by a respective acoustic source can be varied to increase or decrease the effectiveness of the dispersal.

In some embodiments, the duration of one or more acoustic signals emitted from a respective acoustic source is varied. For example, in some embodiments, the duration of one or more acoustic signals is increased to lengthen the duration of the dispersal. In some embodiments, the duration of one or more acoustic signals is decreased to shorten the duration of the dispersal.

In some embodiments, the duration of an acoustic signal in the one or more acoustic signals emitted from a respective acoustic source is at least 1 s, at least 2 s, at least 3 s, at least 4 s, at least 5 s, at least 10 s, at least 20 s, at least 30 s, at least 40 s, at least 50 s, at least 1 minute, at least 2 minutes, at least 5 minutes, at least 10 minutes, at least 20 minutes, at least 30 minutes, at least 40 minutes, at least 50 minutes, at least 1 hour, at least 2 hours, at least 3 hours, at least 6 hours, at least 12 hours, or at least 1 day. In some embodiments, the duration of an acoustic signal in the one or more acoustic signals emitted from a respective acoustic source is at least 2 days, at least 3 days, at least 4 days, at least 5 days, at least 6 days, at least 1 week, at least 2 week, at least 3 week, at least 4 weeks, at least 1 month, at least 2 months, at least 3 months, at least 4 months, at least 5 months, at least 6 months, at least 7 months, at least 8 months at least 9 months, at least 10 months, at least 11 months, or at least 1 year. In some embodiments, the duration of an acoustic signal in the one or more acoustic signals emitted from a respective acoustic source is no more than 6 months, no more than 4 months, no more than 3 months, no more than 2 months, no more than 1 months, no more than 2 weeks, no more than 1 week, no more than 3 days, no more than 2 days, no more than 1 day, no more than 12 hours, no more than 6 hours, no more than 3 hours, no more than 1 hour, or no more than 30 minutes. In some embodiments, the duration of an acoustic signal in the one or more acoustic signals emitted from a respective acoustic source is from 1 second to 1 minute, from 1 minute to 10 minutes, from 10 minutes to 30 minutes, from 30 minutes to 1 hour, from 1 hour to 2 hours, from 2 hours to 6 hours, or from 6 hours to 1 day. In some embodiments, the duration of an acoustic signal in the one or more acoustic signals emitted from a respective acoustic source is from 1 day to 1 week, from 1 week to 1 month, from 1 month to 2 months, from 2 months to 4 months, or from 4 months to 1 year. In some embodiments, the duration of an acoustic signal in the one or more acoustic signals emitted from a respective acoustic source falls within another range starting no lower than 1 second and ending no higher than 1 year.

Thus, referring to Blocks 218 and 220, in some embodiments, the one or more first acoustic signals from a first acoustic source are emitted for between one second and one month, or between one day and four months. In some alternative embodiments, the one or more first acoustic signals from the first acoustic source are emitted for longer than four months.

In some embodiments, an acoustic signal in the one or more acoustic signals emitted by a respective acoustic source is emitted at regular intervals (e.g., daily, weekly, monthly, and/or yearly). For instance, in some embodiments, the one or more acoustic signals from a respective acoustic source are emitted at least once per day, at least once per week, at least once per month, and/or at least once per year.

In some embodiments, the one or more acoustic signals from a respective acoustic source are emitted at least 1, at least 2, at least 3, at least 4, at least 5, at least 6, at least 7, at least 8, at least 9, at least 10, at least 15, at least 20, at least 30, at least 40, at least 50, at least 60, at least 70, at least 80, at least 90, or at least 100 times per day. In some embodiments, the one or more acoustic signals from a respective acoustic source are emitted at least 1, at least 2, at least 3, at least 4, at least 5, at least 6, at least 7, at least 8, at least 9, at least 10, at least 20, at least 50, at least 100, at least 500 times per week. In some embodiments, the one or more acoustic signals from a respective acoustic source are emitted at least 1, at least 2, at least 3, at least 4, at least 5, at least 6, at least 7, at least 8, at least 9, at least 10, at least 20, at least 50, at least 100, at least 500, or at least 1000 times per month. In some embodiments, the one or more acoustic signals from a respective acoustic source are emitted no more than 1000, no more than 500, no more than 100, no more than 50, or no more than 10 times per month. In some embodiments, the one or more acoustic signals from a respective acoustic source are emitted no more than 500, no more than 100, no more than 50, no more than 10, or no more than 5 times per week. In some embodiments, the one or more acoustic signals from a respective acoustic source are emitted no more than 50, no more than 20, no more than 10, or no more than 2 times per day.

In some embodiments, the one or more acoustic signals from a respective acoustic source are emitted at a desired time of year (e.g., a specific month of the year and/or a specific season such as summer).

In some such embodiments, the time and/or duration of emitting the one or more acoustic signals from the respective acoustic source is selected by a user. In some embodiments, the change in frequency is hardwired or programmed (e.g., using a pattern of intervals and/or durations programmed for a desired pattern of emission).

In some embodiments, the one or more first acoustic signals are analog or electronic. In some embodiments, the one or more first acoustic signals are converted from digital to analog (e.g., using a converter).

In some embodiments, any of the corresponding parameters of a respective acoustic signal (e.g., waveform, frequency, intensity, duration, and/or pattern) can be modulated or alternated in order to increase or decrease the range, zone size, dispersal, and target insect for dispersal. In some embodiments, any of the corresponding parameters of a respective acoustic signal (e.g., waveform, frequency, intensity, duration, and/or pattern) can be modulated or alternated, as will be apparent to one skilled in the art.

In some embodiments, the one or more acoustic signals from a respective acoustic source are accompanied with one or more additional sounds and/or vibrations in order to mask (e.g., hide) the sound generated from the one or more acoustic signals.

Acoustic sources. In some embodiments, a respective acoustic source (e.g., the first acoustic source) controls the emission of the one or more acoustic signals (e.g., the one or more first acoustic signals). The respective acoustic source can comprise one or more user affordances (e.g., switches, inputs, buttons, and/or dials) to turn on, turn off, diminish, amplify, and/or otherwise modulate the intensity, duration, frequency, and/or pattern of the one or more acoustic signals. In some embodiments, the one or more user affordances are electronic (e.g., contained on a device, such as a mobile device). In some embodiments, the one or more user affordances are hardware contained in a first acoustic source. Referring to Block 222, in some embodiments, a respective acoustic source (e.g., the first acoustic source) is a speaker.

The speaker can comprise one or more printed circuit boards, optionally comprising an amplifier circuit for amplifying the one or more acoustic signals. In some embodiments, the size of the zone from which the insects (e.g., flying insects) are dispelled is determined by the rating of the amplifier circuit chosen for the application. In some embodiments, the size of the zone from which the insects are dispelled is determined by the selection and placement of the speakers used to radiate the sound (e.g., vibrations) generated. In some embodiments, the size of the speaker is selected based at least in part on the ability of the speaker to emit acoustic signals throughout the desired zone.

In some embodiments, the speaker is encased in a housing. In some embodiments, the speaker is connected to an electronic storage medium that stores the one or more acoustic signals to be emitted. In some embodiments, the speaker is further connected to an amplifier that accesses and amplifies the acoustic signal.

In some embodiments, a respective acoustic source (e.g., the first acoustic source) is a plurality of speakers.

For instance, in some embodiments, the one or more acoustic sources is a plurality of speakers comprising at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 25, at least 30, at least 35, at least 40, at least 45, or at least 50 speakers. In some embodiments, the one or more acoustic sources is a plurality of speakers comprising no more than 100, no more than 50, no more than 40, no more than 30, no more than 20, no more than 10, or no more than 5 speakers. In some embodiments, the one or more acoustic sources is a plurality of speakers comprising from 1 to 5, from 2 to 10, from 5 to 15, from 10 to 20, from 15 to 30, from 20 to 50, or from 40 to 100 speakers. In some embodiments, the one or more acoustic sources is a plurality of speakers that falls within another range starting no lower than 2 speakers and ending no higher than 100 speakers.

Thus, referring to Block 242, in some embodiments, the method further comprises emitting one or more second acoustic signals from a second acoustic source concurrently to the emitting the one or more first acoustic signals from the first acoustic source. In some embodiments, each respective acoustic signal in the one or more second acoustic signals comprises a corresponding smooth periodic oscillation from the second acoustic source. In some such embodiments, the one or more second acoustic signals comprises any of the characteristics (e.g., intensity, duration, number of acoustic signals, and/or frequency of the smooth periodic oscillation) as described above for any respective acoustic signal including the one or more first acoustic signals. In some embodiments, the second acoustic source comprises any of the characteristics as described above for the first acoustic source (e.g., a speaker).

In some embodiments, when one or more acoustic sources is a plurality of acoustic sources, each respective acoustic source in the plurality of acoustic sources can be the same or different from each other, in terms of types, shapes, sizes, frequency of emitted acoustic signals, intensity of emitted acoustic signals, number of emitted acoustic signals, and/or any other characteristics of the emitted acoustic signals. It should be noted, however, that the specific types, sizes, characteristics and/or other parameters of the plurality of acoustic sources or the components thereof can be varied in accordance with the corresponding one or more acoustic signals, application of the acoustic signals, preference of a user, or other factors.

Devices. Another aspect of the present disclosure provides a computing device comprising one or more processors, a memory, and a first acoustic source, where the first acoustic source is in electrical communication with the one or more processors, the memory comprising non-transitory instructions that, when executed by the one or more processors, perform a method. The method comprises receiving, at the computing device, a request to disrupt flying insect activity of one or more flying insects within a zone about the computing device. Responsive to the request, the method further comprises emitting from the first acoustic source one or more acoustic signals thereby causing the one or more flying insects to depart the zone, where each respective acoustic signal in the one or more first acoustic signals comprises a corresponding smooth periodic oscillation from the first acoustic source, and each corresponding smooth periodic oscillation independently has a frequency between 250 Hz and 1500 Hz.

In some embodiments, the computing device is a mobile device, such as a handheld device. In some embodiments, the computing device is a battery-operated mobile device (e.g., a cell phone, tablet, laptop, etc.). In some alternative embodiments, the computing device is a stationary device, such as a stationary device powered by batteries.

In some embodiments, the computing device comprises one or more programs comprising instructions, in electronic form, for emitting a respective one or more acoustic signals from a respective one or more acoustic sources. In some embodiments, the one or more acoustic signals and the one or more acoustic sources comprise any of the embodiments disclosed herein (see, the sections entitled “Acoustic signals” and “Acoustic sources,” above), or any substitutions, modifications, additions, deletions, and/or combinations thereof, as will be apparent to one skilled in the art.

In some embodiments, the one or more programs are software (e.g., a computer program). In some embodiments, the one or more programs is an application (e.g., an app on a mobile device). In some embodiments, the one or more programs comprises an audio or video recording (e.g., including the respective one or more acoustic signals). In some embodiments, the one or more programs are obtained via downloading from a cloud-based server (e.g., the Internet).

In some embodiments, a single computing device can control a plurality of acoustic sources (e.g., a first acoustic source and a second acoustic source). In some embodiments, a single computing device can control at least two, at least three, at least four, at least 10, at least 20, at least 50, or at least 100 acoustic sources. In some embodiments, a single computing device can control any one or more of the acoustic sources disclosed herein (see, the section entitled “Acoustic sources,” above).

For example, the computing device can comprise one or more printed circuit boards including a digital storage medium for storing the one or more acoustic signals and a pre-amplifier for accessing the one or more acoustic signals and producing an analog signal. In some embodiments, the computing device comprises a converter that converts the one or more acoustic signals from digital form, when the acoustic signals are accessed from the digital storage medium, to analog form.

In some embodiments, the computing device comprises an integrated sensor responsive to a remote-control receiver. For example, components and circuitry can be selected to enable remote control operation of power on/off and volume control effective at a specified range, such as an infrared or RF receiver to accommodate the remote on/off and volume control commands of the device, and/or an integrated sensor responsive to a remote control. Sensors can further be provided to actuate the mosquito-dispersing device and emit the one or more acoustic signals to disperse mosquitos including sensors of the sound and/or vibrations of the mosquitos' wing beat and/or sensors responsive to the diminishment of ambient light at dusk when mosquito activity peaks.

Furthermore, the computing device can include a power supply for powering the means for generating and the means for amplifying the one or more acoustic signals. Alternatively, the power supply can comprise a battery or a standard alternating current unit. For instance, a commercially available, regulated 5 Volt DC power supply 22, powered by a 120 Volt AC source, can be used to supply the power to these components. Alternatively, a DC battery supply can be employed. In some embodiments, the components will comprise a precision timer, resistors, capacitors, and switches. The components, other than the precision timer will be rated and arranged so as to provide input to the precision timer. The desired output of the precision timer will be determined by the chosen rating of the resistors and capacitors applied to the precision timer inputs. This output will then be applied to the stereo inputs of a commercially available amplifier circuit. This amplifier circuit can then be used to drive a speaker, broadcasting the effect to the desired area.

In some embodiments, the printed circuit boards of the computing device accept the electronic components required to produce the desired effect.

Other examples of elements that can be used in the printed circuit boards include an integrated pre-amplifier, an integrated stereo amplifier, speaker connections to the amplifier outputs, universal power supply, line voltage connection type, common outdoor rated universal power cord, transformer, on/off switch with connecting leads for remote mounting, LED lights, volume control, and/or flash ROM circuitry.

For example, a pre-amplifier is an audio component that adjusts the volume of an audio signal and performs switching functions between attached input devices and an amplifier. The preamplifier's primary task is volume control and source control. It is used to choose between attached components and let only one pass along its signal. It is also used to adjust the balance, the treble and the bass, where balance is the amount of sound put out by one speaker versus another and usually a left versus right stereo pair.

A stereo amplifier is an electronic component that accepts a low-level signal and recreates the signal with more power; this term is most often used in audio to describe an audio component which takes in line-level audio signals through interconnect cables and outputs a high-powered replica of the input in order to drive speakers and create sound. The signals sent over interconnect cables through an audio system between system components carry the same signal as amplifier outputs just in a low-power form. If the output of a pre-amplifier were given directly to a speaker, the signal would not be strong enough to create movement of the voice coil and thus create sound. The amplifier takes in the signal and increases its power so that the speaker's voice coil will be sufficiently excited to generate movement and thus sound.

The pre-amplifier will have integrated connections that will be used to pass the sound signals to the stereo amplifier, e.g., control voltage connection points to supply voltage necessary to power the pre-amplifier and/or connection points that will be used to connect the leads that provide power for the LED that will indicate power on status of the device.

Programmable flash read-only memory (FEPROM, sometimes called “Flash ROM”) is a type of nonvolatile memory that can be erased and reprogrammed in-circuit. It is a variation of electrically erasable programmable read-only memory (EEPROM).

Nonvolatile memory is a term describing a storage device whose contents are preserved when its power is off. In some embodiments, the Flash ROM circuitry is programmed to emit the one or more acoustic signals in an endless loop.

Alternatively, the computing device for emitting the one or more acoustic signals can comprise a pulse circuit developing one or more acoustic signals of a select one or more frequencies in the range disclosed herein. The pulse circuit may comprise a monostable timer circuit. The monostable timer circuit can comprise an integrated time circuit connected to an RC circuit, where resistance and capacitance of the RC circuit is selected to provide the select one or more frequencies.

In general, component selection can include materials rated for exposure to temperatures ranging from −30° F. to 120° F. In some embodiments, one or more components of the computing device are selected based at least in part on the rating of the one or more components for outdoor use.

In some embodiments, the computing device comprises instructions that, when executed by the one or more processors, perform any of the methods and/or embodiments of the methods described herein.

Another aspect of the present disclosure provides a non-transitory computer readable storage medium, where the non-transitory computer readable storage medium stores instructions, which when executed by a computer system, cause the computer system to perform a method for disrupting flying insect activity of one or more flying insects within a zone. The method comprises emitting one or more first acoustic signals from a first acoustic source thereby causing the one or more flying insects to depart the zone, where each respective acoustic signal in the one or more first acoustic signals comprises a corresponding smooth periodic oscillation from the first acoustic source, and each corresponding smooth periodic oscillation independently has a frequency between 250 Hz and 1500 Hz.

In some embodiments, the non-transitory computer readable storage medium stores instructions, which when executed by a computer system, cause the computer system to perform any of the methods and/or embodiments of the methods described herein.

Not all of the processes disclosed herein are necessary, and some processes are additional or optional.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will be understood that, although the terms “first,” “second,” etc. may be used herein to describe various elements, these elements should not be limited by these terms. These terms are only used to distinguish one element from another. For example, a first acoustic signal could be termed a second acoustic signal, and, similarly, a second acoustic signal could be termed a first acoustic signal, without changing the meaning of the description, so long as all occurrences of the “first acoustic signal” are renamed consistently and all occurrences of the “second acoustic signal” are renamed consistently.

All patents, patent publications, and other published references mentioned herein are hereby incorporated by reference in their entireties as if each had been individually and specifically incorporated by reference herein.

While specific examples have been provided, the above description is illustrative and not restrictive. Any one or more of the features of the previously described embodiments can be combined in any manner with one or more features of any other embodiments in the present invention. Furthermore, many variations of the invention will become apparent to those skilled in the art upon review of the specification. The scope of the invention should, therefore, be determined by reference to the appended claims, along with their full scope of equivalents.

What is claimed is:

1. A method of disrupting flying insect activity of one or more flying insects within a zone, the method comprising emitting one or more first acoustic signals from a first acoustic source thereby causing the one or more flying insects to depart the zone, wherein
each respective acoustic signal in the one or more first acoustic signals comprises a corresponding smooth periodic oscillation from the first acoustic source, and
each corresponding smooth periodic oscillation independently has a frequency between 250 Hz and 1500 Hz.

2. The method of claim 1, wherein the one or more flying insects are mosquitos.

3. The method of claim 1, wherein the one or more flying insects are Aedes, Culex, or Anopheles.

4. The method of claim 1, wherein the one or more flying insects are Aedes aegypti or Aedes albopictus.

5. The method of claim 1, wherein the one or more first acoustic signals consists of a single acoustic signal.

6. The method of claim 1, wherein
the one or more first acoustics signals comprises a plurality of acoustic signals including a first acoustic signal and a second acoustic signal, and
the corresponding smooth periodic oscillation of the second acoustic signal has a frequency other than the frequency of the corresponding smooth periodic oscillation of the first acoustic signal.

7. The method of claim 6, wherein the plurality of acoustic signals comprises five or more acoustic signals, wherein the corresponding smooth periodic oscillation of each respective acoustic signal in the plurality of acoustic signals has a unique frequency.

8. The method of claim 6, wherein the plurality of acoustic signals consists of between ten and one thousand acoustic signals, wherein the corresponding smooth periodic oscillation of each respective acoustic signal in the plurality of acoustic signals has a unique frequency.

9. The method of claim 1, wherein each corresponding smooth periodic oscillation has a frequency between 250 Hz and 1000 Hz.

10. The method of claim 1, wherein each corresponding smooth periodic oscillation has a frequency between 500 Hz and 1500 Hz.

11. The method of claim 1, wherein each corresponding smooth periodic oscillation has a frequency between 500 Hz and 1000 Hz.

12. The method of claim 1, wherein the zone is a radius of between 0.5 meter and 10 meters about the first acoustic source.

13. The method of claim 1, wherein an acoustic signal in the one or more first acoustic signals is emitted from the first acoustic source at a decibel rating of less than 10 dB.

14. The method of claim 1, wherein an acoustic signal in the one or more acoustic signals is emitted from the first acoustic source at a decibel rating of less than 20 dB.

15. The method of claim 1, wherein an acoustic signal in the one or more first acoustic signals is emitted from the first acoustic source at a decibel rating of between 5 dB and 70 dB.

16. The method of claim 1, wherein the one or more first acoustic signals are emitted for between one second and one month.

17. The method of claim 1, wherein the one or more first acoustic signals are emitted for between one day and four months.

18. The method of claim 1, wherein the first acoustic source is a speaker.

19. The method of claim 1, the method further comprising emitting one or more second acoustic signals from a second acoustic source concurrently to the emitting the one or more first acoustic signals from the first acoustic source.

20. A computing device comprising one or more processors, a memory, and a first acoustic source, wherein the first acoustic source is in electrical communication with the one or more processors, the memory comprising non-transitory instructions that, when executed by the one or more processors, perform a method comprising:
receiving, at the computing device, a request to disrupt flying insect activity of one or more flying insects within a zone about the computing device; and
responsive to the request, emitting from the first acoustic source one or more acoustic signals thereby causing the one or more flying insects to depart the zone, wherein
each respective acoustic signal in the one or more first acoustic signals comprises a corresponding smooth periodic oscillation from the first acoustic source, and
each corresponding smooth periodic oscillation independently has a frequency between 250 Hz and 1500 Hz.

21. The computing device of claim 20, wherein the computing device is a battery-operated mobile device.

22. A non-transitory computer readable storage medium, wherein the non-transitory computer readable storage medium stores instructions, which when executed by a computer system, cause the computer system to perform a method for disrupting flying insect activity of one or more flying insects within a zone, the method comprising:
emitting one or more first acoustic signals from a first acoustic source thereby causing the one or more flying insects to depart the zone, wherein
each respective acoustic signal in the one or more first acoustic signals comprises a corresponding smooth periodic oscillation from the first acoustic source, and
each corresponding smooth periodic oscillation independently has a frequency between 250 Hz and 1500 Hz.
